(19) United States
(12) Patent Application Publication
(10) Pub. No.: US 2014/0128265 A1
(43) Pub. Date: May 8, 2014

(54) Compositions Containing Copolymers

(71) Applicant: Andreas Wacker, Mannheim (DE)

(72) Inventor: Andreas Wacker, Mannheim (DE)

(73) Assignee: CLARIANT FINANCE (BVI) LIMITED, Tortola (VG)

(21) Appl. No.: 14/003,533

(22) PCT Filed: Mar. 8, 2012
(86) PCT No.: PCT/EP2012/001027

§ 371 Date: Dec. 11, 2013

(30) Foreign Application Priority Data
Mar. 10, 2011 (DE) 10 2011 013 556.1

(51) Int. Cl. A01N 25/10; C08K 5/101; C08K 5/01

(52) U.S. Cl. CPC A01N 25/10; C08K 5/01; C08K 5/101
USPC 504/195; 524/601; 524/318; 504/309; 504/272; 504/317; 504/342

(57) ABSTRACT

The invention relates to compositions that contain A) one or more copolymers, said copolymers containing one or more structural units obtained from a) 19.9 to 75.9 wt. % glycerin, b) 0.1 to 30 wt. % at least one dicarboxylic acid, and c) 24 to 80 wt. % at least one monocarboxylic acid according to formula (I) R¹—COOH (I), in which R¹ is (C₅-C₂₉)-alkyl; (C₇-C₂₉)-alkenyl; phenyl; or naphthyl, and B) one or more solvents that are not miscible with water. The invention is characterized in that said compounds either do not contain water or contain water in a quantity less than or equal to 1.0 wt. % with respect to the total weight of the respective composition. The compositions are advantageously suitable for producing pesticide compositions for example.

The invention relates to compositions of copolymers in water-immiscible solvents, where the compositions comprise no water or water in an amount of less than or equal to 1.0% by weight. The copolymers contain structural units derived from glycerol, dicarboxylic acids and monocarboxylic acids in specific quantitative ratios.

Copolymers obtainable by copolymerization of glycerol, at least one dicarboxylic acid and at least one monocarboxylic acid are known from EP 1 379 129 and US 2009/156407. In a pure state, the copolymers are very high-viscosity, honey- to wax-like substances which are difficult to handle in undiluted form. The use of the copolymers as a 75 to 90% strength by weight aqueous solution is therefore recommended. In fact, the copolymers are also marketed in the form of aqueous preparations (for example under the trade name Synergen® GL 5 from Clariant) and are used as formulation auxiliaries in aqueous pesticide preparations, particularly in glyphosate preparations. Moreover, EP 1 379 129 teaches that the properties of the copolymers can be influenced via the degree of crosslinking, i.e. via the fraction of dicarboxylic acid.

GB 903 766 describes 3,4-dichloropropionanilides as herbicide and formulations of this active ingredient. Reference is also made here to the general applicability of nonionic condensates of polyglycerols, fatty acids and phthalic acid in self-emulsifiable preparations. Specific examples are not mentioned and the composition of these condensates is also not discussed.

EP 161 595 describes a hair after-treatment composition in the form of an aqueous emulsion which comprises complex esters consisting of aliphatic polyols, dicarboxylic acids and aliphatic monocarboxylic acids.

DE 10 2009 041 003.1 describes aqueous pesticide preparations comprising copolymers obtainable by copolymerization of glycerol, at least one dicarboxylic acid and at least one monocarboxylic acid, and also one or more amphoteric surface-active substances.

Within the context of the present invention, the terms “anhydrous” or “non-aqueous” compositions or formulations mean compositions or formulations which either comprise no water or comprise water in an amount of less than or equal to 1.0% by weight, based on the total weight of the respective composition or formulation.

Pesticide preparations can in principle be divided into liquid and solid types (formulations). Compared with the liquid formulations, solid formulations have the disadvantage that they are more difficult to dose and to distribute homogeneously in the spray liquor. Moreover, they are generally less effective since it is very difficult to formulate an adjuvant into solid preparations.

Liquid formulations can in principle be divided into aqueous and non-aqueous types. Non-aqueous formulations comprise one or more (mostly water-immiscible) solvents and are anhydrous. Despite the general trend to use preferably aqueous formulations from the points of view of environmental protection, non-aqueous pesticide preparations continue to play a large role. Most active ingredients have a considerably higher solubility in a solvent than in water. Non-aqueous formulations are often more biologically effective, more storage-stable or hydrolysis-sensitive active ingredients can anyway only be formulated on an anhydrous basis.

Formulation auxiliaries in non-aqueous pesticide preparations that are very often used are ethoxylation products or alkoxylation products of long-chain alcohols or phenols (alcohol alkoxylates), which function as emulsifier, wetting agent or adjuvant. However, they have the disadvantage that they are based on ethylene oxide and propylene oxide, which in turn are produced from ethene and propene and therefore petrochemical raw materials. In view of the increasing shortage and cost of crude oil and its secondary products and also a growing environmental awareness, there is an increasing need for formulation auxiliaries which utilize a natural raw material basis.

There is therefore a need for new types of formulation auxiliaries which do not have the aforementioned disadvantages and which can be used in non-aqueous pesticide preparations.

It was therefore an object of the present invention to provide compositions which are based for the greatest part on renewable raw materials, are user-friendly to handle and which can be used for producing non-aqueous pesticide preparations.

It has now been found that this object is achieved by non-aqueous compositions comprising A) one or more specific copolymers, where the copolymers contain one or more structural units derived from glycerol, at least one dicarboxylic acid and at least one monocarboxylic acid, and B) one or more water-immiscible solvents.

The invention therefore provides compositions comprising
A) one or more copolymers, where the copolymers contain one or more structural units derived from
a) 19.9 to 75.9% by weight of glycerol
b) 0.1 to 30% by weight of at least one dicarboxylic acid and
c) 24 to 80% by weight of at least one monocarboxylic acid according to formula (I)

R¹—COOH (I)
where R¹ is (C₅-C₂₉)-alkyl; (C₇-C₂₉)-alkenyl; phenyl or naphthyl,
and
B) one or more water-immiscible solvents,
wherein the compositions either comprise no water or comprise water in an amount of less than or equal to 1.0% by weight, based on the total weight of the compositions.

The specified fractions of monomers a), b) and c) (in % by weight) relate to the total amount of the monomers as used for producing the copolymers, they do not relate to the end composition of the copolymers, which differs slightly as a result of the elimination of water released during the condensation.

EP 1 379 129 explicitly discloses that the properties of the copolymers specified therein, such as the solubility in water, can be influenced via the degree of crosslinking, i.e. via the fraction of the dicarboxylic acid. Surprisingly, however, it has now been found that the fraction of the dicarboxylic acid has no influence on the solubility of the copolymers according to component A) of the compositions according to the invention in water-immiscible solvents, but is determined merely by the fraction of the monocarboxylic acid.

The fundamentally possible compositions of the copolymers, and also the preparation and embodiments of the copolymerization are described in EP 1 379 129. It is common knowledge that the condensation reactions proceed between alcohols and/or carboxylic acids, i.e. the monomers are joined together by ether bonds (in the case of the condensation of two alcohol functions of glycerol) or by ester bonds (in the case of the condensation of an alcohol function of glycerol with a carboxylic acid function of the mono- or dicarboxylic acid).

The copolymers of component A) of the compositions according to the invention are preferably prepared by firstly condensing monoglycerol to give an oligo- or polyglycerol and only then reacting it with the at least one dicarboxylic acid b) and the at least one monocarboxylic acid c). The result of this is that the copolymers of component A) of the compositions according to the invention in this preferred embodiment of the invention comprise condensed oligo- or polyglycerol units.

The at least one dicarboxylic acid b) is preferably oxalic acid; a dicarboxylic acid according to formula (II)

HOOC—R²—COOH (II)

and/or a dicarboxylic acid according to formula (III)

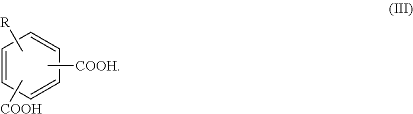

where R² is a (C₁-C₄₀)-alkylene bridge or a (C₂-C₂₀)-alkenylene bridge and R is H, (C₁-C₂₀)-alkyl, (C₂-C₂₀)-alkenyl, phenyl, benzyl, halogen, —NO₂, (C₁-C₆)-alkoxy, —CHO or —CO((C₁-C₆)-alkyl).

Particularly preferably, the at least one dicarboxylic acid b) is phthalic acid and the at least one monocarboxylic acid c) is coconut fatty acid.

Preferably, the one or more copolymers of component A) present in the compositions according to the invention consist of the components a), b) and c).

The majority of the raw materials which are required for producing the copolymers originates from renewable raw material sources. Glycerol is nowadays a by-product of biodiesel manufacture, the monocarboxylic acids are obtained from animal or vegetable fats or oils, only the dicarboxylic acid is usually of synthetic origin.

As already mentioned, within the context of the present invention, “anhydrous” or “non-aqueous” compositions are understood as meaning compositions which comprise either no water or water in an amount of less than or equal to 1.0% by weight, based on the total weight of the respective composition. Preferably, the compositions according to the invention comprise less than 0.5% by weight of water, based on the total weight of the respective composition. These water contents usually result from residual amounts of water which is formed as a by-product during the condensation of the copolymers, are already present in the solvents used or are introduced in the course of producing the compositions as an impurity during the process.

The water-immiscible solvents are solvents which have a solubility at room temperature (25° C.) of at most 5% by weight and preferably of at most 1% by weight in water. All water-immiscible solvents as are also customarily used in pesticide preparations can expediently be used here.

Examples of such solvents are alkanes, aromatic hydrocarbons, solvent naphtha, alcohols, esters, ketones, amides, ethers, phosphoric and phosphonic acid esters, vegetable oils, mineral oils, alkyl esters of fatty acids of vegetable or animal origin.

They are preferably solvent naphtha, fatty acid amides, vegetable oils, mineral oils, and also short-chain esters of fatty acids of vegetable or animal origin.

Particularly preferred water-immiscible solvents within the context of the present invention are solvent naphtha, fatty acid dimethylamides, vegetable oils, mineral oils or methyl esters of fatty acids of vegetable or animal origin.

The solvents primarily have the task of converting the per se high-viscosity and difficult-to-handle copolymers of component A) of the compositions according to the invention into a liquid presentation form having sufficiently low viscosity.

The fraction of the one or more copolymers of component A) in the compositions according to the invention is preferably 1 to 90% by weight, particularly preferably 10 to 80% by weight and especially preferably 20 to 70% by weight and the fraction of the one or more water-immiscible solvents of component B) is preferably 10 to 99% by weight, particularly preferably 20 to 90% by weight and especially preferably 30 to 80% by weight. These quantitative data are based on the total weight of the compositions according to the invention.

Besides copolymer and solvent, the compositions according to the invention can comprise further additives which can assume different functions. Examples of auxiliaries according to their function are additional solvents, emulsifiers, adjuvants, wetting agents, penetration promoters, low-temperature stabilizers, colorants, antifoams, antioxidants, antifreezes.

The compositions according to the invention can be used for producing anhydrous pesticide preparations. This results in compositions according to the invention which comprise one or more pesticides.

In a preferred embodiment of the invention, the compositions according to the invention therefore additionally comprise one or more pesticides. Such compositions according to the invention are also referred to below as “pesticide compositions according to the invention”.

Preferred pesticide compositions according to the invention are emulsion concentrates (ECs) and oil dispersions (ODs).

In an emulsion concentrate, the one or more pesticides is present in dissolved form in a solvent. In an oil dispersion, the one or more pesticides is present in dispersed form in a solvent (the oil). The “oil” does not necessarily have to be an oil in the classic sense (such as a mineral oil or vegetable oil). Rather, it is understood as meaning any solvent that is immiscible with water.

Within the context of the present invention, “pesticides” are herbicides, fungicides, insecticides, acaricides, bactericides, molluscides, nematicides and rodenticides, and also phytohormones. Phytohormones control physiological reactions, such as growth, flowering rhythm, cell division and seed ripening. An overview of the most relevant pesticides can be found for example in “The Pesticide Manual” from the British Crop Protection Council, 14^{th} Edition 2006, Editor: C D S Tomlin.

The pesticides of the compositions according to the invention are preferably selected from the group consisting of herbicides, insecticides and fungicides.

Preferred fungicides are aliphatic nitrogen fungicides, amide fungicides such as acylamino acid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboxamide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides.

Preferred herbicides are amide herbicides, anilide herbicides, aromatic acid herbicides such as benzoic acid herbicides or picolinic acid herbicides, benzoylcyclohexanedione herbicides, benzofuranyl alkylsulfonate herbicides, benzothiazole herbicides, carbamate herbicides, carbanilate herbicides, cyclohexene oxime herbicides, cyclopropylisoxazole herbicides, dicarboximide herbicides, dinitroaniline herbicides, dinitrophenol herbicides, diphenyl ether herbicides, dithiocarbamate herbicides, imidazolinone herbicides, isoxazolidinone herbicides, nitrile herbicides, organophosphorus herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, pyrazole herbicides such as benzoylpyrazole herbicides or phenylpyrazole herbicides, pyridazinone herbicides, pyridine herbicides, thiocarbamate herbicides, triazine herbicides, triazinone herbicides, triazole herbicides, triazolone herbicides, triazolopyrimidine herbicides, uracil herbicides, urea herbicides such as phenylurea herbicides or sulfonylurea herbicides.

Preferred insecticides are carbamate insecticides, such as benzofuranyl methylcarbamate insecticides or dimethylcarbamate insecticides or oxime carbamate insecticides or phenyl methylcarbamate insecticides, diamide insecticides, insect growth regulators, macrocyclic lactone insecticides such as avermectin insecticides or milbemycin insecticides or spinosyn insecticides, nereistoxin analogous insecticides, nicotinoid insecticides such as nitroguanidine nicotinoid insecticides or pyridylmethylaminenicotinoid insecticides, organophosphorus insecticides such as organophosphate insecticides or organothiophosphate insecticides or phosphinate insecticides or phosphoramidothioate insecticides, oxadiazine insecticides, pyrazole insecticides, pyrethroid insecticides such as pyrethroid ester insecticides or pyrethroid ether insecticides or pyrethroid oxime insecticides, tetramic acid insecticides, tetrahydrofurandione insecticides, thiazole insecticides.

The pesticides are especially preferably triazole fungicides, strobilurin fungicides, neonicotinoid insecticides, organophosphate insecticides, pyrethroid insecticides, phenoxyacetic acid herbicides, isoxazolidinone herbicides, cyclohexene oxime herbicides or sulfonylurea herbicides.

The pesticides are particularly preferably tebuconazole, propiconazole, epoxiconazole, prothioconazole, cyproconazole, azoxystrobin, trifloxystrobin, imidacloprid, thiacloprid, chlorpyrifos, chlorpyrifos-methyl, isomeric cypermethrins, isomeric cyhalothrins, 2,4-D-esters, clomazone, clethodim, nicosulfurone, iodosulfurone and mesosulfurone.

The one or more copolymers of component A) can serve several purposes in the pesticide compositions according to the invention. On account of their chemical structure, they can act primarily as emulsifier, wetting agent or dispersant. The latter is primarily of relevance for oil dispersions.

The one or more copolymers of component A) can also contribute to increasing the biological effectiveness of the pesticide, i.e. function as adjuvant. An adjuvant is understood as meaning auxiliaries which increase the biological effectiveness of the active ingredients without themselves exhibiting a biological effect, by, for example, improving the wetting, the retention or the absorption into the plant or the target organism.

The pesticide compositions according to the invention can optionally comprise further auxiliaries such as thickeners, dispersants, wetting agents, emulsifiers, preservatives, adjuvants, penetration promoters, low-temperature stabilizers, colorants, antifoams and antioxidants.

Thickeners which can be used are all substances that can customarily be used for this purpose in agrochemical formulations, such as xanthan gum, cellulose, for example carboxy-, methyl-, ethyl- or propylcellulose, (optionally modified) bentonites, (optionally surface-modified) silicon dioxide.

Suitable additional solvents are all substances that can customarily be used for this purpose in agrochemical formulations, including water-miscible solvents provided they are anhydrous. Examples of solvents are alkanes, aromatic hydrocarbons, solvent naphtha, alcohols, esters, ketones such as cyclohexanone, acetophenone, amides such as octanoic, decanoic and dodecanoic acid dimethylamide, lactic acid dimethylamide, ethers, phosphoric acid esters such as tris(ethylhexyl) phosphate, phosphonic acid esters such as bis(ethylhexyl)ethylhexylphosphonate, vegetable oils, mineral oils, alkyl esters of fatty acids of vegetable or animal origin, pyrrolidones such as N-methyl and N-ethylpyrrolidone, butyrolactone, lactic acid ester such as ethyl lactate, ethylhexyl lactate, esters of carbonic acid such as propylene carbonate, glycols or polyglycols.

Suitable dispersants and wetting agents are all substances that can customarily be used for this purpose in agrochemical formulations, such as nonionic, amphoteric, cationic and anionic (polymeric) surfactants.

Preferred dispersants and wetting agents are fatty alcohol ethoxylates, fatty alcohol alkoxylates, EO/PO block copolymers (EO: ethyleneoxy unit; PO: propyleneoxy unit), alkylarylsulfonic acids, alkylsulfonic acids, sulfonic acids of ethoxylated alcohols, sulfosuccinates, fatty acid methyltaurides, tristyrylphenol ethoxylates and alkoxylates, tri-sec-butylphenol ethoxylates, sulfated cresol-formaldehyde condensation products, sulfated condensation products of naphthalene and alkylnaphthalenes, lignosulfonates, phosphoric acid esters of ethoxylated fatty alcohols, tristyrylphenols and tri-sec-butylphenols, and ethersulfates of ethoxylated fatty alcohols, tristyrylphenols and tri-sec-butylphenols and polymeric dispersants.

Suitable emulsifiers are nonionic and anionic emulsifiers such as ethoxylates or alkoxylates of long-chain (C₈ to C₂₄) linear or branched alcohols, EO/PO block copolymers (EO: ethyleneoxy unit; PO: propyleneoxy unit), alkylphenol or tristyrylphenol ethoxylates and alkoxylates, tri-sec-butylphenol ethoxylates, castor oil ethoxylates, esters of long-chain carboxylic acids with mono- or polyhydric alcohols and ethoxylation products thereof, salts of dodecylbenzenesulfonic acid, sulfosuccinates, phosphoric acid esters of ethoxylated fatty alcohols, tristyrylphenols and tri-sec-butylphenols and salts thereof.

Preservatives which can be used are all substances that can usually be used for this purpose in agrochemical formulations, such as organic acids and their esters, for example ascorbic acid, ascorbic palmitate, sorbate, benzoic acid, methyl and propyl 4-hydroxybenzoate, propionates, phenol, for example 2-phenylphenate, 1,2-benzisothiazolin-3-one, formaldehyde.

Adjuvants which can be used are all substances that can customarily be used for this purpose in agrochemical formulations, such as alcohol alkoxylates, fatty amine ethoxylates, esters of phosphorous acid or of phosphoric acid, such as bis(ethylhexyl)ethylhexylphosphonate or tris(ethylhexyl) phosphate, sorbitan and sorbitol ethoxylate derivatives.

Suitable penetration promoters are all substances which are customarily used in order to improve the penetration of pesticides into plants or into target organisms. Penetration promoters can be defined for example by the fact that they penetrate into the cuticle of the plant from the aqueous spray liquor and/or from a spray covering on the plant surface and are thereby able to increase the mobility of active ingredients in the cuticle. The method described in the literature can be used for determining this property (Baur et al., 1997, Pesticide Science 51, 131-152).

Low-temperature stabilizers may be all substances that can customarily be used for this purpose in agrochemical formulations. By way of example, mention may be made of urea, glycerol and propylene glycol.

Suitable colorants are all substances that can customarily be used for this purpose in agrochemical formulations, such as oil-soluble dyes, and also organic or inorganic pigments.

Suitable antifoams are all substances that can customarily be used for this purpose in agrochemical formulations, such as fatty acid alkyl ester alkoxylates; organopolysiloxanes such as polydimethylsiloxanes and mixtures thereof with microfine, optionally silanized silica; perfluoroalkyl phosphonates and phosphinates; paraffins; waxes and microcrystalline waxes and mixtures thereof with silanized silica. Mixtures of different foam inhibitors, for example those of silicone oil, paraffin oil and/or waxes are also advantageous.

Suitable antioxidants are all substances that can customarily be used for this purpose in agrochemical formulations, such as, for example, BHT (2,6-di-tert-butyl-4-methylphenol).

The fraction of the one or more copolymers of component A) in the pesticide compositions according to the invention is preferably 0.1 to 40% by weight, particularly preferably 0.5 to 30% by weight and especially preferably 1 to 20% by weight. These quantitative data are based on the total weight of the pesticide compositions according to the invention.

Furthermore, the fraction of the one or more pesticides in the pesticide compositions according to the invention is preferably 0.1 to 75% by weight, particularly preferably 5 to 50% by weight and especially preferably 10 to 40% by weight. These quantitative data are based on the total weight of the pesticide compositions according to the invention.

In the just-mentioned pesticide compositions according to the invention, the fraction of the one or more water-immiscible solvents of component B) is preferably 1 to 99.8% by weight, particularly preferably 5 to 80% by weight and especially preferably 10 to 70% by weight. These quantitative data are based on the total weight of the pesticide compositions according to the invention.

The pesticide compositions according to the invention are preferably applied to the fields in the form of spray liquors. In this connection, a spray liquor is prepared e.g. by diluting a concentrate formulation, such as, for example, an emulsion concentrate according to the invention or an oil dispersion according to the invention, with a defined amount of water.

The compositions according to the invention can also be used as a tank-mix adjuvant. A tank-mix adjuvant is an auxiliary which contains no pesticide, but is processed with one or more pesticides and optionally further additives, such as, for example, fertilizers, before applying the pesticide to give a spray liquor, and leads to an increase in the biological activity of the pesticide. An overview of the most common types of tank-mix adjuvants can be found in the “Compendium of Herbicide Adjuvants” by Bryan G. Young, 10^{th} Edition, 2010.

Whether the copolymer composition is also suitable from practical aspects directly as a tank-mix adjuvant depends on the structure of the copolymer, the type of solvent and the fraction of copolymer and/or of water-immiscible solvent in the composition. On account of the surface-active properties of the copolymers, these are able, provided they are present in a sufficient fraction, to emulsify the solvent in an aqueous spray liquor and to thereby attain a homogeneous mixture.

However, the compositions according to the invention are better suited as a tank-mix adjuvant if they additionally comprise one or more surface-active substances.

For example, in this connection, the compositions according to the invention can also be used for producing anhydrous compositions comprising one or more surface-active substances. This results in compositions according to the invention which comprise one or more surface-active substances.

In one preferred embodiment of the invention, the compositions according to the invention therefore additionally comprise one or more surface-active substances. Such compositions according to the invention are also referred to below as “adjuvant compositions according to the invention”.

The surface-active substances serve to convert the adjuvant compositions according to the invention, upon dilution with water, into an emulsion in which the copolymer and the solvent are homogeneously distributed.

Particularly suitable surface-active substances are ethoxylates or alkoxylates of long-chain (C₈ to C₂₄) linear or branched alcohols, EO/PO block copolymers (EO: ethyleneoxy unit; PO: propyleneoxy unit), alkylphenol or tristyrylphenol ethoxylates and alkoxylates, tri-sec-butylphenol ethoxylates, castor oil ethoxylates, esters of long-chain carboxylic acids with mono- or polyhydric alcohols, and ethoxylation products thereof, salts of dodecylbenzenesulfonic acid, sulfosuccinates, phosphoric acid esters of ethoxylated fatty alcohols, tristyrylphenols and tri-sec-butylphenols and salts thereof.

Such an adjuvant composition according to the invention can also be referred to as crop oil concentrate. A crop oil concentrate (COC) is a special form of a tank-mix adjuvant, usually consisting of a mineral or vegetable oil and/or a fatty acid methyl or ethyl ester, and one or more emulsifiers or wetting agents. Other customary names for Crop Oil Concentrates are Crop Oil, High Surfactant Oil Concentrate or Vegetable Oil Concentrate or Methylated or Ethylated Vegetable Oil.

In the adjuvant compositions according to the invention, the fraction of the one or more copolymers of component A) is preferably 1 to 90% by weight, particularly preferably 2 to 60% by weight and especially preferably 5 to 50% by weight. These quantitative data are based on the total weight of the adjuvant compositions according to the invention.

In the adjuvant compositions according to the invention, the fraction of the one or more surface-active substances is preferably 0.1 to 50% by weight, particularly preferably 1 to 30% by weight and especially preferably 2 to 20% by weight. These quantitative data are based on the total weight of the adjuvant compositions according to the invention.

In the just-mentioned adjuvant compositions according to the invention, the fraction of the one or more water-immiscible solvents of component B) is preferably 1 to 98.9% by weight, particularly preferably 20 to 80% by weight and especially preferably 48 to 90% by weight. These quantitative data are based on the total weight of the adjuvant compositions according to the invention.

The compositions according to the invention can also be used for producing anhydrous compositions comprising one or more pesticides and simultaneously one or more surface-active substances. This results in compositions according to the invention which comprise one or more pesticides and one or more surface-active substances.

In a further preferred embodiment of the invention, the compositions according to the invention therefore additionally comprise one or more pesticides and one or more surface-active substances. Such compositions according to the invention are also referred to below as “pesticide compositions according to the invention containing surface-active substances”.

In the pesticide compositions according to the invention containing surface-active substances,

the fraction of the one or more copolymers of component A) is preferably 0.1 to 40% by weight, particularly preferably 0.5 to 30% by weight and especially preferably 1 to 20% by weight,
the fraction of the one or more pesticides is preferably 0.1 to 75% by weight, particularly preferably 5 to 50% by weight and especially preferably 10 to 40% by weight and
the fraction of the one or more surface-active substances is preferably 0.1 to 30% by weight, particularly preferably 0.5 to 25% by weight and especially preferably 1 to 20% by weight. These quantitative data are based on the total weight of the pesticide compositions according to the invention containing surface-active substances.

In the just-mentioned pesticide compositions according to the invention containing surface-active substances, the fraction of the one or more water-immiscible solvents of component B) is preferably 1 to 99.7% by weight, particularly preferably 5 to 80% by weight and especially preferably 10 to 70% by weight. These quantitative data are based on the total weight of the pesticide compositions according to the invention containing surface-active substances.

As already mentioned, the compositions according to the invention can for example be used for producing pesticide compositions according to the invention, for producing adjuvant compositions according to the invention or for producing pesticide compositions according to the invention containing surface-active substances.

The present invention therefore further provides the use of a composition according to the invention for producing pesticide compositions according to the invention, for producing adjuvant compositions according to the invention or for producing pesticide compositions according to the invention containing surface-active substances.

The compositions according to the invention can also be used for producing aqueous emulsions.

The present invention therefore further provides the use of a composition according to the invention for producing aqueous emulsions.

The pesticide compositions according to the invention can be produced in different ways depending on the type of formulation, said ways being sufficiently known to the person skilled in the art. The adjuvant compositions according to the invention can also be produced in different ways, which are sufficiently known to the person skilled in the art. The same applies to the production of the pesticide compositions according to the invention containing surface-active substances and for the production of aqueous emulsions from compositions according to the invention.

### EXAMPLES

The invention is illustrated below by reference to examples, although these are in no way to be regarded as a limitation.

The commercial products used are:

| | |
|---|---|
| Emulsogen ® TS 299 | tristyrylphenol ethoxylate (20 EO) from |
| | Clariant |
| Emulsogen ® EP 4901 | butanol-based EO/PO copolymer from Clariant |
| Emulsogen ® 3510 | butanol-based EO/PO copolymer from Clariant |
| Emulsogen ® EL 360 | ethoxylated castor oil (36 EO) from Clariant |
| Emulsogen ® EL 400 | ethoxylated castor oil (40 EO) from Clariant |
| Genapol ® C 030 | ethoxylated coconut fatty alcohol (3 EO) from |
| | Clariant |
| Marcol ® 82 | mineral oil from Exxon |
| Phenylsulfonate CA | branched Ca dodecylbenzylsulfonate in |
| | isobutanol from Clariant (70% strength by |
| | weight) |
| Phenylsulfonate CAL | linear Ca dodecylbenzylsulfonate in isobutanol |
| | from Clariant (70% strength by weight) |
| Solvesso ® 200 ND | aromatic hydrocarbon mixture from Exxon |
| | (solvent naphtha) |
| Solvesso ® 150 | aromatic hydrocarbon mixture from Exxon |
| | (solvent naphtha) |
| Synergen ® KN | fungicide adjuvant from Clariant |
| | (100% strength) |

### Preparation Examples

### General Procedure for the Preparation of Copolymers 1 to 12

The preparation of the copolymers takes place in two steps, where, in the first step, glycerol is condensed to give the corresponding polyglycerol, which is then reacted with monocarboxylic acid and dicarboxylic acid to give the copolymer.

Preparation of polyglycerol (n=9.7): 2000 g of glycerol and 6.0 g of NaOH (50% by weight in water) were heated to 270° C. in a stirred apparatus with nitrogen introduction and water separator with stirring. After a reaction time of 9 hours and a discharge of 444 g of water, a sample was taken and the OH number was determined. The ascertained OH number was 891 mg KOH/g. This corresponds to an average degree of condensation n of 9.7 glycerol units.

Preparation of polyglycerol (n=5.0): 2000 g of glycerol and 6.0 g of NaOH (50% by weight in water) were heated to 270° C. in a stirred apparatus with nitrogen introduction and water separator with stirring. After a reaction time of 4 hours and a discharge of 226 g of water, a sample was taken and the OH number was determined. The ascertained OH number was 1009 mg KOH/g. This corresponds to an average degree of condensation n of 5.0 glycerol units.

The method described in DIN 53240 is used for determining the OH number.

Condensation of polyglycerol with mono- and dicarboxylic acid to give the copolymer: the polyglycerol was placed into a stirred container with N₂ passage and water separator and admixed with coconut fatty acid (C_{8/18}) and phthalic acid. The reaction mixture was then heated to 220° C. with stirring until the copolymer has an acid value of <1.00 mg KOH/g (three to nine hours).

The method described in DIN EN ISO 2114 is used for determining the acid value.

Table 1 gives the absolute amounts used for the monomers for the preparation of copolymers 1-12 as well as the percent by weight composition of copolymers 1-7 (for compositions according to the invention) and of copolymers 8-12 (for comparison compositions).

The weight percentage compositions of copolymers 1-12 given in Table 1 relate to the total amount of the monomers as used for the preparation of the copolymers. They do not relate to the end composition of the copolymers, which differs as a result of the elimination of water liberated during the condensation.

TABLE 1
Composition of the copolymers

| | | | | | | | Fraction |
|---|---|---|---|---|---|---|---|
| | | | | | | Fraction | of |
| | | | | | Fraction | of | coconut |
| | | | | Coconut | of | phthalic | fatty |
| | | | Phthalic | fatty | glycerol | acid | acid |
| Co- | Glycerol | | acid | acid | [% by | [% by | [% by |
| polymer | [g] | n | [g] | [g] | wt.] | wt.] | wt.] |
| 1 | 460 | 5.0 | 1.7 | 408 | 52.9 | 0.2 | 46.9 |
| 2 | 460 | 5.0 | 17 | 408 | 52.0 | 1.9 | 46.1 |
| 3 | 218 | 9.7 | 40.4 | 98.8 | 61.0 | 11.3 | 27.7 |
| 4 | 460 | 5.0 | 166 | 204 | 55.4 | 20.0 | 24.6 |
| 5 | 218 | 9.7 | 83 | 98.8 | 54.5 | 20.8 | 24.7 |
| 6 | 460 | 5.0 | 166 | 408 | 44.5 | 16.1 | 39.5 |
| 7 | 460 | 5.0 | 166 | 712 | 34.4 | 12.4 | 53.2 |
| 8 | 218 | 9.7 | 10.1 | 24.7 | 86.2 | 4.0 | 9.8 |
| (comp.) | | | | | | | |
| 9 | 218 | 9.7 | 40.4 | 49.4 | 70.8 | 13.1 | 16.0 |
| (comp.) | | | | | | | |
| 10 | 218 | 9.7 | 40.4 | 74.1 | 65.6 | 12.2 | 22.3 |
| (comp.) | | | | | | | |
| 11 | 218 | 9.7 | 4 | 24.7 | 88.4 | 1.6 | 10.0 |
| (comp.) | | | | | | | |
| 12 | 218 | 5.0 | 40.4 | 24.7 | 77.0 | 14.3 | 8.7 |
| (comp.) | | | | | | | |

n: average degree of condensation of the glycerol;
comp.: comparison

### Determination of the Solubilities of the Copolymers in Water-Immiscible Solvents:

5 g of each of the copolymers 1 to 12 are admixed in a beaker with 95 g of rapeseed oil methyl ester or Solvesso® 200 ND and stirred for 3 hours.

TABLE 2
Solubility of the copolymers in nonpolar solvents

| Copolymer | Rapeseed oil methyl ester | Solvesso ® 200 ND |
|---|---|---|
| 1 | Clearly dissolved | Clearly dissolved |
| 2 | Clearly dissolved | Clearly dissolved |
| 3 | Clearly dissolved | Clearly dissolved |
| 4 | Clearly dissolved | Clearly dissolved |
| 5 | Clearly dissolved | Clearly dissolved |
| 6 | Clearly dissolved | Clearly dissolved |
| 7 | Clearly dissolved | Clearly dissolved |
| 8 (comp.) | Insoluble | Insoluble |
| 9 (comp.) | Insoluble | Insoluble |
| 10 (comp.) | Insoluble | Insoluble |
| 11 (comp.) | Insoluble | Insoluble |
| 12 (comp.) | Insoluble | Insoluble |

comp.: comparison

The results show that the solubility in the water-immiscible solvents is decisively dependent on the fraction of the coconut fatty acid and not on the fraction of the phthalic acid.

### Preparation of the Copolymer Compositions According to the Invention

### Example 1

600 g of copolymer 2 are introduced into 400 g of Solvesso® 200 ND with stirring. This gives a clear, brown viscous solution.

### Example 2

600 g of copolymer 2 are introduced into 400 g of rapessed oil methyl ester with stirring. This gives a clear, brown viscous solution.

### Example 3

700 g of copolymer 2 are introduced into 300 g of Solvesso® 200 ND with stirring. This gives a clear, brown viscous solution.

### Example 4

300 g of copolymer 2 are introduced into 700 g of Solvesso® 200 ND with stirring. This gives a clear, brown viscous solution.

### Example 5

600 g of copolymer 5 are introduced into 400 g of rapeseed oil methyl ester with stirring. This gives a clear, brown viscous solution.

### Example 6

600 g of copolymer 5 are introduced into 400 g of Solvesso® 200 ND with stirring. This gives a clear, brown viscous solution.

### Example 7

600 g of copolymer 7 are introduced into 400 g of Solvesso® 200 ND with stirring. This gives a clear, brown viscous solution.

### Example 8

600 g of copolymer 7 are introduced into 400 g of Solvesso® 200 ND with stirring. This gives a clear, brown viscous solution.

All copolymer compositions from examples 1 to 8 are subjected to a storage test. For this, the solutions are stored for 14 days at 54° C. and then for 7 days at 0° C. All of the solutions are still homogeneous after storage and show no signs of separation.

### APPLICATION EXAMPLES

Pesticide compositions (emulsion concentrates) are prepared from the components specified in each of the individual examples.

### Application Example 1

### Lambda-Cyhalothrin EC

50.9 g of lambda-cyhalothrin
30.0 g of phenylsulfonate CAL
30.0 g of Emulsogen® EL 400
100.0 g of a 60% strength by weight solution of copolymer 5 in rapeseed oil methyl ester
695.0 g of rapeseed oil methyl ester

### Application Example 2

### Chlorpyrifos EC

211.0 g of chlorpyrifos (97% by weight)
50.0 g of phenylsulfonate CA
45.0 g of Emulsogen® EL 360
5.0 g of Emulsogen® 3510
80.0 g of a 60% strength by weight solution of copolymer 2 in Solvesso® 200 ND
609.0 g of Solvesso® 150

### Application Example 3

### Tebuconazole EC

206.0 g of tebuconazole (97% by weight)
60.0 g of Emulsogen® EP 4901
40.0 g of Emulsogen® TS 200
50.0 g of a 60% strength by weight solution of copolymer 7 in Solvesso® 200 ND
150.0 g of Synergen® KN
250.0 g of acetophenone
250.0 g of 2-ethylhexanol

### Application Example 4

### 2,4-D-Isooctyl ester EC

632.0 g of 2,4-D-isooctyl ester (95% by weight)
17.0 g of phenylsulfonate CA
24.0 g of Emulsogen® EL 360
50.0 g of a 60% strength by weight solution of copolymer 2 in Solvesso® 200 ND
277.0 g of Solvesso® 150

### Application Example 5

### Acetochlor EC

262.0 g of acetochlor (94% by weight)
120.0 g of a 60% strength by weight solution of copolymer 7 in Solvesso® 200 ND
164.0 g of Solvesso® 150

All of the compositions of application examples 1 to 5 produce storage-stable EC formulations which show no signs of separation or precipitation after storage for 14 days at 54° C. and then storage for 7 days at 0° C. To assess the quality of the formulations, 5% strength by weight aqueous emulsions in soft (20 ppm) and hard (342 ppm) CIPAC-standard water are prepared and assessed at 30° C. after a period of 2, 4 and 24 hours. All of the emulsions are stable over this period; phase separation is not observed.

### Application Example 6

### Adjuvant Composition (Crop Oil Concentrate)

A Crop Oil Concentrate is prepared from the following components:
138.0 g of Genapol® C 030
15.0 g of phenylsulfonate CAL
200.0 g of a 60% strength by weight solution of copolymer 5 in Solvesso® 200 ND
647.0 g of Marcol® 82

The composition of application example 6 produces a storage-stable Crop

Oil Concentrate which shows no sign of separation or precipitation after storage for 14 days at 54° C. and then storage for 7 days at 0° C. To assess the quality, 5% strength by weight aqueous emulsions in soft (20 ppm) and hard (342 ppm) CIPAC-standard water are prepared and assessed at 30° C. after a period of 2, 4 and 24 hours. The emulsion is stable over this period; phase separation is not observed.

1. A composition comprising
A) at least one copolymer, where the at least one copolymer contains at least one structural unit derived from
a) 19.9 to 75.9% by weight of glycerol
b) 0.1 to 30% by weight of phthalic acid and
c) 24 to 80% by weight of coconut fatty acid
and are prepared by firstly condensing monoglycerol to give an oligo- or polyglycerol and only then reacting it with the phthalic acid and the coconut fatty acid
and
B) at least one water-immiscible solvent,
wherein the composition either comprises no water or comprises water in an amount of less than or equal to 1.0% by weight, based on the total weight of the composition.

2. The composition as claimed in claim 1, wherein the at least one water-immiscible solvent is solvent naphtha, fatty acid dimethylamides, vegetable oils, mineral oils or methyl esters of fatty acids of vegetable or animal origin.

3. The composition as claimed in claim 1, wherein
the fraction of the at least one copolymer of component A) is 1 to 90% by weight and
the fraction of the at least one water-immiscible solvent of component B) is 10 to 99% by weight.

4. The composition as claimed in claim 1, wherein it further comprises at least one pesticide.

5. The composition as claimed in claim 4, wherein it is an emulsion concentrate or an oil dispersion.

6. The composition as claimed in claim 4, wherein
the fraction of the at least one copolymer of component A) is 0.1 to 40% by weight and
the fraction of the at least one pesticide is 0.1 to 75% by weight.

7. The composition as claimed in claim 6, wherein the fraction of the at least one water-immiscible solvent of component B) is 1 to 99.8% by weight.

8. The composition as claimed in claim 1, wherein it further comprises at least one surface-active substance.

9. The composition as claimed in claim 8, wherein the fraction of the at least one copolymer of component A) is 1 to 90% by weight and
the fraction of the at least one surface-active substance is 0.1 to 50% by weight.

10. The composition as claimed in claim 9, wherein the fraction of the at least one water-immiscible solvent of component B) is 1 to 98.9% by weight.

11. The composition as claimed in claim 1, wherein it further comprises at least one pesticide and at least one surface-active substance.

12. The composition as claimed in claim 11, wherein the fraction of the at least one copolymer of component A) is 0.1 to 40% by weight,
the fraction of the at least one pesticide is 0.1 to 75% by weight and
the fraction of the at least one surface-active substance is 0.1 to 30% by weight.

13. The composition as claimed in claim 12, wherein the fraction of the at least one water-immiscible solvent of component B) is 1 to 99.7% by weight.

14. A process for producing an aqueous emulsion comprising the step of adding at least one composition as claimed in claim 1 to the aqueous emulsion.
